(19) United States
(12) Patent Application Publication
(10) Pub. No.: US 2004/0190138 A1
(43) Pub. Date: Sep. 30, 2004

(54) Resin composition for optical film, optical film and process for producing the optical film

(75) Inventors: Shinsuke Toyomasu, Yokkaichi-shi (JP); Yojiro Ikai, Yokkaichi-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOSOH CORPORATION, Shunan-shi (JP)

(21) Appl. No.: 10/802,851

(22) Filed: Mar. 18, 2004

(30) Foreign Application Priority Data
Mar. 31, 2003 (JP) 2003-094888
Feb. 2, 2004 (JP) 2004-025549

(51) Int. Cl. C08L 39/04

(52) U.S. Cl. 359/494; 525/203; 264/2.7

(57) ABSTRACT

A resin composition having excellent heat resistance and dynamic characteristic and having excellent characteristics as a composition for optical films exhibiting negative birefringence, an optical film exhibiting negative birefringence comprising the resin composition, and a process of producing the optical film are provided. The resin composition comprises (a) 30-95% by weight of a copolymer containing an α-olefin residual group unit and an N-phenyl-substituted maleimide residual group unit and having a weight average molecular weight, as reduced into standard polystyrene, of 5×10³ to 5×10⁶; and (b) 70-5% by weight of an acrylonitrile-styrene based copolymer, a weight ratio of an acrylonitrile residual group unit to a styrene residual group unit being 20/80 to 35/65, and having a weight average molecular weight, as reduced into standard polystyrene, of 5×10³ to 5×10⁶.

### FIELD OF THE INVENTION

The present invention relates to a resin composition having excellent heat resistance and dynamic characteristic and having excellent characteristics as a composition for optical films exhibiting negative birefringence, an optical film exhibiting negative birefringence comprising the same, and a process of producing the optical film.

### DESCRIPTION OF THE RELATED ART

In recent years, thin liquid crystal display elements and electroluminescence elements have been developed in place of cathode-ray television monitors, and film materials having controlled optical anisotropy are being demanded. It is the present state that transparent resin materials are versatilely used as optical films from the standpoints of lightweight properties, productivity and costs.

Hitherto, stretching and orientation of films have been carried out as a method of revealing optical anisotropy of transparent resin materials. It is known that according to the stretching and orientation, films made of polymethyl methacrylate (hereinafter referred to as “PMMA”) or polystyrene (hereinafter referred to as “PS”) exhibit negative birefringence, whereas films made of a polycarbonate (hereinafter referred to as “PC”) or an amorphous cyclic polyolefin (hereinafter referred as “APO”) exhibit positive birefringence (see, for example, Yasuhiro Koike, Kobunshi No One Point 10, Kobunshi No Hikari Bussei, published on May 10, 2000 by Kyoritsu Shuppan Co., Ltd., and Koji Minami, Function & Materials, August, Vol. 20, No. 8, pp. 23-33 (2000), published on Aug. 5, 2000 by CMC Publishing Co., Ltd.).

However, PMMA and PS were limited with respect to applications because they have a glass transition temperature (hereinafter referred to as “Tg”) in the vicinity of 100° C. so that the heat resistance is insufficient, and are brittle. On the other hand, although PC and APO have a Tg of around 140° C. so that they are excellent in heat resistance and dynamic characteristic, they are a material exhibiting positive birefringence but not a material exhibiting negative birefringence, which exhibits transparent and heat resistance and is dynamically excellent. Accordingly, it is the present state that optical films are wholly produced using a resin material exhibiting positive birefringence and that heat resistant optical films exhibiting negative birefringence are not available yet.

It is known that with respect to maleimide based copolymers, a copolymer comprising a phenylmaleimide residual group and an α-olefin residual group exhibits thermodynamic miscibility within a specific proportion range in a blend with a copolymer comprising a styrene residual group and an acrylonitrile residual group (see, for example, U.S. Pat. No. 4,605,700).

However, with respect to the copolymer comprising a phenylmaleimide residual group and an α-olefin residual group, there is no information regarding peculiar optical characteristics of a blend with a copolymer comprising a styrene residual group and an acrylonitrile residual group and a film made of the blend.

### SUMMARY OF THE INVENTION

The present invention has been made under the above circumstance.

One object of the present invention is to provide a resin composition having excellent heat resistance and dynamic characteristic and having excellent characteristics as a composition for optical films exhibiting negative birefringence.

Another object of the present invention is to provide an optical film exhibiting negative birefringence comprising the resin composition.

Still another object of the present invention is to provide a process of producing the optical film.

The present inventors made extensive and intensive investigations on the above-described problems. As a result, it has been found that an optical film comprising a resin composition comprising a specific copolymer comprising an α-olefin residual group unit and an N-phenyl-substituted maleimide residual group unit and a specific acrylonitrile-styrene based copolymer becomes an optical film exhibiting negative birefringence, leading to accomplishment of the present invention.

The present invention provides a resin composition for optical film exhibiting negative birefringence, which comprises

(a) 30-95% by weight of a copolymer comprising an α-olefin residual group unit represented by the following formula (i) and an N-phenyl-substituted maleimide residual group unit represented by the following formula (ii), and having a weight average molecular weight, as reduced into standard polystyrene, of from 5×10³ to 5×10⁶, and

(b) 70-5% by weight of at least one acrylonitrile-styrene based copolymer selected from an acrylonitrile-styrene copolymer and an acrylonitrile-butadiene-styrene copolymer, a weight ratio of an acrylonitrile residual group unit to a styrene residual group unit being 20/80 to 35/65, and having a weight average molecular weight, as reduced into standard polystyrene, of 5×10³ to 5×10⁶;

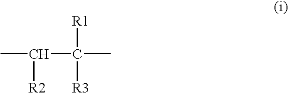

wherein R1, R2, and R3 each independently represent hydrogen or an alkyl group having 1-6 carbon atoms;

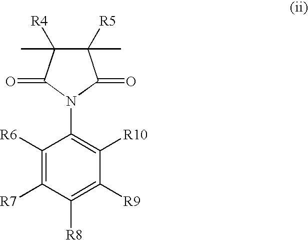

wherein R4 and R5 each independently represent hydrogen, or a linear or branched alkyl group having 1-8 carbon atoms; and R6, R7, R8, R9 and R10 each independently represent hydrogen, a halogen atom, a carboxylic acid, a carboxylic acid ester, a hydroxyl group, a cyano group, a nitro group, or a linear or branched alkyl group having 1-8 carbon atoms.

The present invention further provides an optical film exhibiting negative birefringence comprising the resin composition.

The present invention also provides a process of producing the optical film exhibiting negative birefringence, which comprises forming a resin composition for optical film exhibiting negative birefringence, comprising

(a) 30-95% by weight of a copolymer comprising an α-olefin residual group unit represented by the above-described formula (i) and an N-phenyl-substituted maleimide residual group unit represented by the above-described formula (ii), having a weight average molecular weight, as reduced into standard polystyrene, of 5×10³ to 5×10⁶; and

(b) 70-5% by weight of at least one acrylonitrile-styrene based copolymer selected from an acrylonitrile-styrene copolymer and an acrylonitrile-butadiene-styrene copolymer, a weight ratio of an acrylonitrile residual group unit to a styrene residual group unit being 20/80 to 35/65, and having a weight average molecular weight, as reduced into standard polystyrene, of 5×10³ to 5×10⁶ into a film; and stretching and orienting the film at a temperature in the range of from [(glass transition temperature of the resin composition)−20 ° C.] to [(glass transition temperature of the resin composition)+20 ° C.].

### BRIEF DESCRIPTION OF THE DRAWINGS

FIG. 1 is a drawing showing the axis directions of three-dimensional refractive indexes of an optical film.

FIG. 2 is a drawing showing three-dimensional refractive indexes of an optical film exhibiting negative birefringence by uniaxial stretching.

FIG. 3 is a drawing showing three-dimensional refractive indexes of an optical film exhibiting negative birefringence by biaxial stretching.

### DETAILED DESCRIPTION OF THE INVENTION

The copolymer (a) used in the present invention is a copolymer comprising an α-olefin residual group unit represented by the above-described formula (i) and an N-phenyl-substituted maleimide residual group unit represented by the above-described formula (ii) and having a weight average molecular weight, as reduced into standard polystyrene, of 5×10³ to 5×10⁶. The weight average molecular weight can be obtained by measuring an elution curve of the copolymer by gel permeation chromatography (hereinafter referred to as “GPC”) as a value reduced into standard polystyrene. In the case where the weight average molecular weight of the copolymer (a) as reduced into polystyrene is less than 5×10³, not only processability in molding the resulting resin composition into an optical film becomes difficult, but also the resulting optical film becomes brittle. On the other hand, in the case where the weight average molecular weight exceeds 5×10⁶, processability in molding the resulting resin composition into an optical film becomes difficult.

The copolymer (a) used in the present invention preferably has a molar ratio of the α-olefin residual group unit represented by the formula (i) to the N-phenyl-substituted maleimide residual group unit represented by the formula (ii) of 70/30 to 30/70 because a resin composition having especially excellent heat resistance and mechanical property can be obtained. More preferably, the copolymer (a) is an alternating copolymer resulting from alternate copolymerization of the α-olefin residual group unit represented by the formula (i) and the N-phenyl-substituted maleimide residual group unit represented by the formula (ii).

In the α-olefin residual group unit represented by the formula (i) constituting the copolymer (a), R1, R2 and R3 each independently represent hydrogen or an alkyl group having 1-6 carbon atoms. Examples of the alkyl group having 1-6 carbon atoms include a methyl group, an ethyl group, an n-propyl group, an isopropyl group, an n-butyl group, a sec-butyl group, a tert-butyl group, an n-pentyl group, a 2-pentyl group, an n-hexyl group, and a 2-hexyl group. In the case where R1, R2 and R3 each represent an alkyl substituent of more than 6 carbon atoms, there are problems such that the glass transition temperature of the copolymer becomes markedly low or that the copolymer becomes crystalline, thereby deteriorating the transparency. Specific examples of compounds capable of introducing the α-olefin residual group unit represented by the formula (i) include isobutene, 2-methyl-1-butene, 2-methyl-1-pentene, 2-methyl-1-hexene, 2-methyl-1-heptene, 1-isooctene, 2-methyl-1-octene, 2-ethyl-1-pentene, 2-methyl-2-pentene, 2-methyl-2-hexene, ethylene, propylene, 1-butene, and 1-hexene. Of these, α-olefins belonging to 1,2-di-substituted olefins are preferable, and isobutene is especially preferable because the copolymer (a) having excellent heat resistance, transparency and dynamic characteristic is obtained. The α-olefin residual group unit may be used alone or as mixtures of two or more thereof, and its ratio is not particularly limited.

In the N-phenyl-substituted maleimide residual group unit represented by the formula (ii) constituting the copolymer (a), R4 and R5 each independently represent hydrogen, or a linear or branched alkyl group having 1-8 carbon atoms. Examples of the linear or branched alkyl group having 1-8 carbon atoms include a methyl group, an ethyl group, an n-propyl group, an isopropyl group, an n-butyl group, a sec-butyl group, a tert-butyl group, an n-pentyl group, a 2-pentyl group, an n-hexyl group, a 2-hexyl group, an n-heptyl group, a 2-heptyl group, a 3-heptyl group, an n-octyl group, a 2-octyl group, and a 3-octyl group. R6, R7, R8, R9 and R10 each independently represent hydrogen, a halogen atom, a carboxylic acid, a carboxylic acid ester, a hydroxyl group, a cyano group, a nitro group, or a linear or branched alkyl group having 1-8 carbon atoms. Examples of the halogen atom include fluorine, bromine, chlorine, and iodine. Examples of the carboxylic acid ester include methyl carboxylate and ethyl carboxylate. Examples of the linear or branched alkyl group having 1-8 carbon atoms include a methyl group, an ethyl group, an n-propyl group, an isopropyl group, an n-butyl group, a sec-butyl group, a tert-butyl group, an n-pentyl group, a 2-pentyl group, an n-hexyl group, a 2-hexyl group, an n-heptyl group, a 2-heptyl group, a 3-heptyl group, an n-octyl group, a 2-octyl group, and a 3-octyl group. In the case where R4, R5, R6, R7, R8, R9 and R10 each represent an alkyl substituent of more than 8 carbon atoms, there are problems such that the glass transition temperature of the copolymer becomes markedly low or that the copolymer becomes crystalline, thereby deteriorating the transparency.

Examples of compounds capable of introducing the N-phenyl-substituted maleimide residual group unit represented by the formula (ii) include maleimide compounds in which an unsubstituted phenyl group or a substituted phenyl group is introduced as an N substituent of a maleimide compound. Specific examples include N-phenylmaleimide, N-(2-methylphenyl)maleimide, N-(2-ethylphenyl)maleimide, N-(2-n-propylpheny)maleimide, N-(2-isopropylphenyl)maleimide, N-(2-n-butylphenyl)maleimide, N-(2-sec-butylphenyl)maleimide, N-(2-t-butylphenyl)maleimide, N-(2-n-pentylphenyl)maleimide, N-(2-t-pentylphenyl)maleimide, N-(2,6-dimethylphenyl)maleimide, N-(2,6-diethylphenyl)maleimide, N-(2,6-di-n-propylphenyl)maleimide, N-(2,6-di-isopropylphenyl)maleimide, N-(2-methyl, 6-ethylphenyl)maleimide, N-(2-methyl, 6-isopropylphenyl)maleimide, N-(2-chlorophenyl)maleimide, N-(2-bromophenyl)maleimide, N-(2,6-dichlorophenyl)maleimide, N-(2,6-dibromophenyl)maleimide, N-2-biphenylmaleimide, N-2-diphenyl ether maleimide, N-(2-cyanophenyl)maleimide, N-(2-nitrophenyl)maleimide, N-(2,4,6-trimethylphenyl)maleimide, N-(2,4-dimethylphenyl)maleimide, N-perbromophenylmaleimide, N-(2-methyl, 4-hydroxyphenyl)maleimide, and N-(2,6-diethyl, 4-hydroxyphenyl)maleimide. Of these, N-phenylmaleimide, N-(2-methylphenyl)maleimide, N-(2-ethylphenyl)maleimide, N-(2-n-propylphenyl)maleimide, N-(2-isopropylphenyl)maleimide, N-(2-n-butylphenyl)maleimide, N-(2-sec-butylphenyl)maleimide, N-(2-t-butylphenyl)maleimide, N-(2-n-pentylphenyl)maleimide, N-(2-t-pentylphenyl)-maleimide, N-(2,6-dimethylphenyl)maleimide, N-(2,6-diethylphenyl)maleimide, N-(2,6-di-n-propylphenyl)maleimide, N-(2,6-diisopropylphenyl)maleimide, N-(2-methyl, 6-ethylphenyl)maleimide, N-(2-methyl, 6-isopropylphenyl)maleimide, N-(2-chlorophenyl)maleimide, N-(2-bromophenyl)maleimide, N-(2,6-dichlorophenyl)maleimide, N-(2,6-dibromophenyl)maleimide, N-2-biphenylmaleimide, N-2-diphenyl ether maleimide, N-(2-cyanophenyl)maleimide, and N-(2-nitrophenyl)maleimide are preferable. Especially, N-phenylmaleimide and N-(2-methylpheny)maleimide are preferable because the copolymer (a) having excellent heat resistance, transparency and dynamic characteristic is obtained. The N-phenyl-substituted maleimide residual group unit may be used alone or as mixtures of two or more thereof, and its ratio is not particularly limited.

The copolymer (a) can be obtained by copolymerizing a compound capable of introducing the α-olefin residual group unit represented by the above-described formula (i) and a compound capable of introducing the N-phenyl-substituted maleimide residual group unit represented by the above-described formula (ii) by applying conventional polymerization methods. Examples of the conventional polymerization methods include block polymerization, solution polymerization, suspension polymerization, and emulsion polymerization. As other methods, the copolymer (a) can be obtained by reacting a copolymer obtained by copolymerizing a compound capable of introducing the α-olefin residual group unit represented by the above-described formula (i) and maleic anhydride with, for example, aniline or an aniline having a substituent introduced at any of the 2- to 6-positions thereof, thereby undergoing dehydration ring-closure imidation.

The copolymer (a) is a copolymer comprising an α-olefin residual group unit represented by the above-described formula (i) and an N-phenyl-substituted maleimide residual group unit represented by the above-described formula (ii), and examples thereof include an N-phenylmaleimide-isobutene copolymer, an N-phenylmaleimide-ethylene copolymer, an N-phenylmaleimide-2-methyl-1-butene copolymer, an N-(2-methylphenyl)maleimide-isobutene copolymer, an N-(2-methylphenyl)maleimide-ethylene copolymer, an N-(2-methylphenyl)maleimide-2-methyl-1-butene copolymer, an N-(2-ethylphenyl)maleimide-isobutene copolymer, an N-(2-ethylphenyl)maleimide-ethylene copolymer, and an N-(2-ethylphenyl)maleimide-2-methyl-1-butene copolymer. Of these, an N-phenylmaleimide-isobutene copolymer and an N-(2-methylphenyl)maleimide-isobutene copolymer are preferable because they are especially excellent in heat resistance, transparency and dynamic characteristic.

The acrylonitrile-styrene based copolymer (b) used in the present invention is an acrylonitrile-styrene copolymer and/or an acrylonitrile-butadiene-styrene copolymer, a weight ratio of an acrylonitrile residual group unit to a styrene residual group unit being 20/80 to 3 5/65, and having a weight average molecular weight, as reduced into standard polystyrene, of 5×10³ to 5×10⁶. The weight average molecular weight can be obtained by measuring an elution curve of the copolymer by GPC as a value reduced into standard polystyrene. In the case where the weight average molecular weight of the acrylonitrile-styrene based copolymer (b) as reduced into polystyrene is less than 5×10³, not only processability in molding the resulting resin composition into an optical film becomes difficult, but also the resulting optical film becomes brittle. On the other hand, in the case where the weight average molecular weight exceeds 5×10^{6,} processability in molding the resulting resin composition into an optical film becomes difficult. In the acrylonitrile-styrene based copolymer (b), in the case where the weight ratio of the acrylonitrile residual group unit to the styrene residual group unit is less than 20/80, a problem encounters such that the dynamic characteristic in the resin composition with the copolymer (a) lowers, whereby the resulting optical film becomes very brittle. On the other hand, in the case where the weight ratio of the acrylonitrile residual group unit to the styrene residual group unit exceeds 35/65, a problem encounters such that change of properties of acrylonitrile is liable to occur, whereby the resulting resin composition is deteriorated in hue or hygroscopicity. In the case where an acrylonitrile-butadiene-styrene copolymer is used as the acrylonitrile-styrene based copolymer (b), the acrylonitrile-butadiene-styrene copolymer preferably contains 1-40 parts by weight of a butadiene residual group unit, per 100 parts by weight of the sum of an acrylonitrile residual group unit and a styrene residual group unit because the resulting resin composition is especially excellent in dynamic characteristic. An acrylonitrile-styrene based copolymer in which a part or the whole of the styrene residual group unit is an α-methylstyrene residual group unit can also be used as the acrylonitrile-styrene based copolymer (b).

Synthesis method of the acrylonitrile-styrene based copolymer (b) used in the present invention can be any conventional polymerization methods. Examples of the conventional polymerization methods include block polymerization, solution polymerization, suspension polymerization, and emulsion polymerization. Commercially available products may be used.

The resin composition for optical film exhibiting negative birefringence according to the present invention comprises 30-95% by weight of the copolymer (a) and 70-5% by weight of the acrylonitrile-styrene based copolymer (b). Especially, a resin composition comprising 40-90% by weight of the copolymer (a) and 60-10% by weight of the acrylonitrile-styrene based copolymer (b) is preferable because it is excellent in balance between heat resistance and dynamic characteristic. In the case where the amount of the copolymer (a) is less than 30% by weight, the heat resistance of the resulting resin composition lowers. On the other hand, in the case where the amount of the copolymer (a) exceeds 95% by weight, the resulting resin composition becomes very brittle and has low dynamic characteristic.

As the preparation method of the resin composition for optical film exhibiting negative birefringence according to the present invention, any method may be employed so far as a resin composition comprising the copolymer (a) and the acrylonitrile-styrene based copolymer (b) can be obtained. Examples the preparation method include a method of preparing a resin composition by heat melting and kneading using a kneading machine such as an internal mixer and an extruder and a method of preparing a resin composition by solution blending using a solvent.

If desired, the resin composition for optical film exhibiting negative birefringence according to the present invention may contain additives such as heat stabilizers or anti-ultraviolet stabilizers, or plasticizers so far as the addition does not deviate from the object of the present invention. Conventional additives or stabilizers usually known for resin materials may be used.

In molding the resin composition for optical film exhibiting negative birefringence according to the present invention into a film, the film is used as an optical film exhibiting negative birefringence. Especially, the film preferably is used as a retardation film exhibiting negative birefringence.

One embodiment of the optical film exhibiting negative birefringence and production process thereof will be described below.

The optical film exhibiting negative birefringence according to the present invention comprises a resin composition comprising (a) 30-95% by weight of a copolymer comprising an α-olefin residual group unit represented by the above-described formula (i) and an N-phenyl-substituted maleimide residual group unit represented by the above-described formula (ii), and having a weight average molecular weight, as reduced into standard polystyrene, of 5×10³ to 5×10⁶, and (b) 70-5% by weight of at least one acrylonitrile-styrene based copolymer selected from an acrylonitrile-styrene copolymer and an acrylonitrile-butadiene-styrene copolymer, a weight ratio of an acrylonitrile residual group unit to a styrene residual group unit being 20/80 to 35/65, and having a weight average molecular weight, as reduced into standard polystyrene, of 5×10³ to 5×10⁶. For example, the resin composition is formed into a film by molding, and the optical film is stretched, thereby obtaining an optical film exhibiting birefringence.

With respect to the film molding method, the film can be obtained by a molding method such as extrusion molding or solvent casting.

The film formation by extrusion molding will be described in detail below.

The above-described resin composition is provided into, for example, an extruder installed with a thin die called as a T-die, such as a single-screw extruder or a twin-screw extruder, and passed through a gap of the die and extruded while heat melting, and the resulting film is drawn up, whereby a film having an arbitrary thickness can be obtained. In the film formation, to suppress appearance failure caused by gas expansion when molding or the like, it is desired that the resin composition is previously heat dried at a temperature in a range of 80-130° C. It is desired that the extrusion molding is carried out by setting up a filter for filtering contaminants according to the desired film thickness and optical purity. Further, to efficiently cool a film in the molten state for solidification and efficiently produce a film having an excellent appearance, it is desired that the extrusion molding is carried out by setting up a low-temperature metal role or steel belt.

With respect to the extrusion molding condition, it is desired that the extrusion molding is carried out under a condition at a shear rate of less than 1,000 sec⁻¹ at a temperature sufficiently higher than the Tg at which the resin composition melt flows due to heating and shear stress.

In extrusion molding the resin composition into a film, when the resulting film is stretched to form an optical film, it is preferred to control the condition such that the degree of orientation of a molecule chain in each of the flow direction, width direction and thickness direction of the film becomes uniform as possible because an optical film having a stable relationship among three-dimensional refractive indexes is efficiently obtained. As such a method, broadly known molding processing techniques can be employed. For example, a method of making the resin composition discharged from a die uniform according to the position, a method of making a cooling step of the film after discharge uniform, and devices related thereto can be employed.

The film formation by the solvent casting will be described in detail below.

It is possible to form a film by dissolving the resin composition in a solvent in which the resin composition is soluble, to prepare a solution, casting the solution, and then removing the solvent.

The solvent used can be any solvent so far as the resin composition is soluble therein. The solvent may be used alone or as mixtures of two or more thereof, as the need arises. Examples of the solvent include methylene chloride, chloroform, chlorobenzene, toluene, xylene, methyl ethyl ketone, acetonitrile, and mixtures thereof Further, for the purpose of controlling the volatilization rate of the solvent during the solvent removal after casting, it is possible to use a combination of a solvent in which the resin composition is soluble (for example, methylene chloride and chloroform) with a poor solvent (for example, alcohols such as methanol or ethanol).

In drying a substrate by solvent casting, it is important that air bubbles or internal voids be not formed by setting up the heating condition, and it is desired that the concentration of the residual solvent is 2 wt % or less at the time of the stretching operation as the subsequent secondary molding/processing. To reveal uniform negative birefringence on the film obtained after stretching, it is desired that the film obtained by the primary molding/processing is free from non-uniform orientation or residual strain and is optically isotropic. As such a method, the solvent casting is preferable.

The film obtained by the molding method such as melt extrusion and solvent casting is stretched to orient the molecular chain of the copolymer, thereby revealing negative birefringence. As a method of orienting the molecular chain, any method is employable so far as the molecular chain can be oriented. For example, a variety of methods such as stretching, rolling or drawing can be employed. Above all, it is especially preferable to produce a film by stretching because an optical film having negative birefringence can be produced with good efficiency. In this regard, uniaxial stretching such as uniaxial free width stretching and uniaxial fixed width stretching; and biaxial stretching such as biaxial sequential stretching and biaxial simultaneous stretching can be employed. As devices for carrying out rolling or the like, for example, a roll stretching machine is known. Besides, any of tenter type stretching machines and small-sized experimental stretching machines such as a tensile testing machine, a uniaxial stretching machine, a biaxial sequential stretching machine, and a biaxial simultaneous stretching machine can be employed.

In carrying out the stretching processing, it is preferable to carry out the stretching at a temperature in the range of from [(Tg of the resin composition)−20° C.] to [(Tg of the resin composition)+20° C.]. This is because it is possible to produce an optical film suitable as a retardation film with good production efficiency for the reason that the optical film efficiently exhibits negative birefringence. The term “Tg” as referred to herein means a region from a temperature at which the storage elastic modulus of the resin composition starts to lower to a temperature at which the orientation of the polymer chain disappears due to relaxation in a temperature region exhibiting a relation of [(loss elastic modulus)>(storage elastic modulus)], and can be measured by a differential scanning calorimeter (DSC).

The stretching temperature in the stretching operation and the strain rate and deformation rate in stretching the film may be properly chosen so far as the object of the present invention can be achieved. In this regard, Kiyoichi Matsumoto, Koblinshi Kako, One Point 2 (Fuirumu Wo Tsukuru), compiled by The Society of Polymer Science, Japan and published on Feb. 15, 1993 by Kyoritsu Shuppan Co., Ltd. can be made hereof by reference.

In the resin composition for optical film and the optical film according to the present invention, especially the retardation film, it is possible to grasp the birefringence characteristic using a retardation amount. In the case of a film comprising the resin composition, the retardation amount as referred to herein can be defined as a value obtained by multiplying of a difference among nx, ny and nz that are three-dimensional indexes in the x-axis direction and y-axis direction within the plane of the film obtained by stretching and in the z-axis direction outside the film plane, respectively by a thickness of the film (d). In this case, specific examples of the difference in the refractive index include a difference in refractive index within the film plane, i.e., (nx−ny); and differences in refractive index outside the film plane, i.e., (nx−nz) and (ny−nz). In evaluating the optical characteristics in terms of the retardation amount, it is also effective to express the retardation amount within the film plane as [Re or Rexy=(nx−ny)d]; and the retardation amount outside the film plane as [Re or Rexz=(nx−nz)d] or [Re or Reyz=(ny−nz)d], respectively.

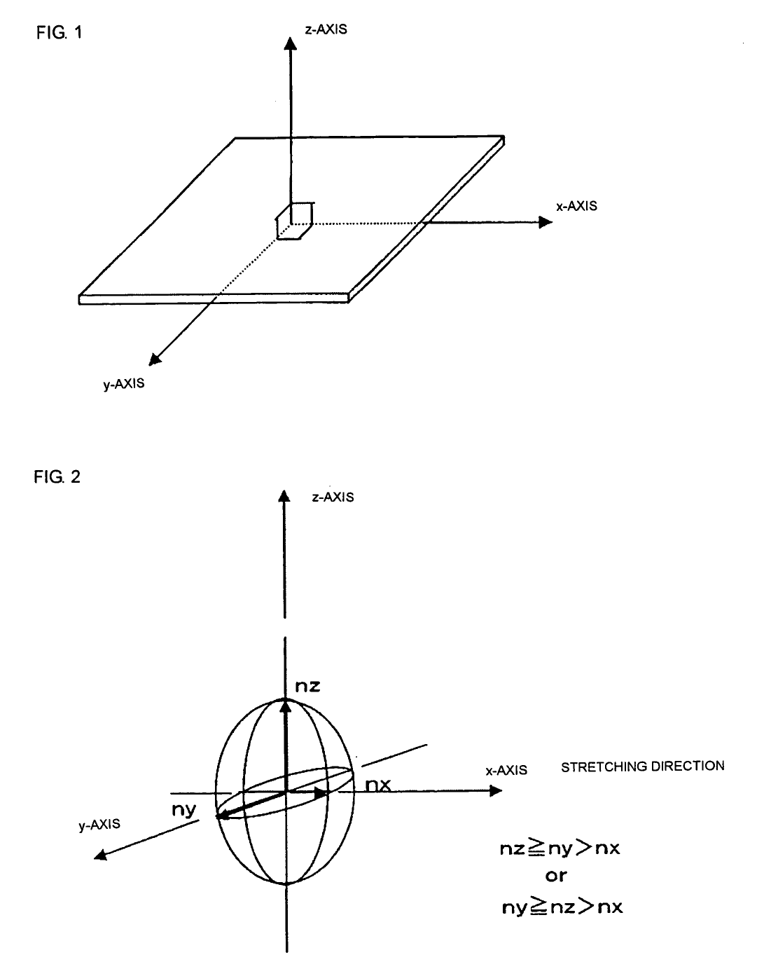

With respect to an optical film obtained by uniaxially stretching and orienting an unoriented film made of the above-described resin composition, in the case where, as shown in FIG. 1, the stretching direction is defined as an x-axis, the direction within the film plane and perpendicular to the x-axis is defined as a y-axis, the direction outside the film plane and perpendicular to the x-axis is defined as a z-axis, a refractive index in the x-axis direction is defined as nx, a refractive index in the y-axis direction is defined as ny, and a refractive index in the z-axis direction is defined as nz, the optical film becomes an optical film exhibiting negative birefringence having the relationship among the three-dimensional refractive indexes of (nz≧ny>nx) or (ny≧nz>nx) as shown in FIG. 2.

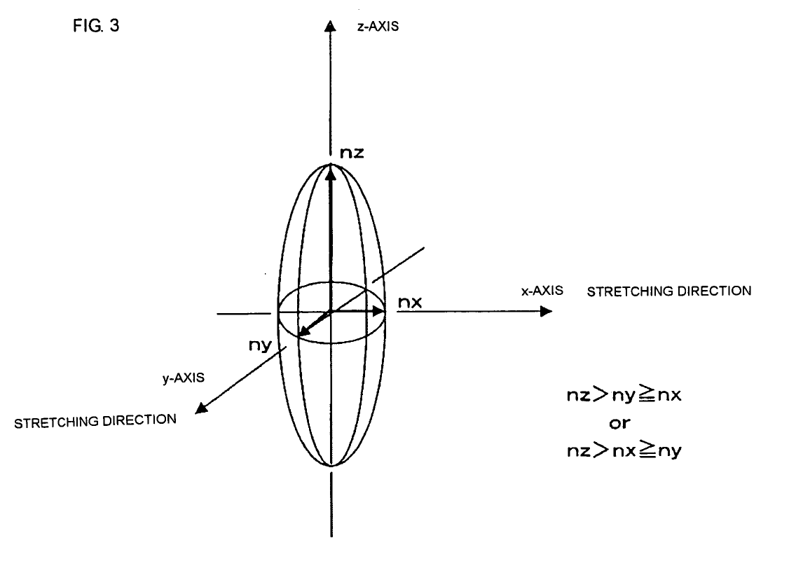

With respect to an optical film obtained by biaxially stretching and orienting an unoriented film comprising the above-described resin composition, in the case where, as shown in FIG. 1, the stretching direction is defined as an x-axis and a y-axis within the film plane, the direction outside the film plane and perpendicular to these axes is defined as a z-axis, a refractive index in the x-axis direction is defined as nx, a refractive index in the y-axis direction is defined as ny, and a refractive index in the z-axis direction is defined as nz, the optical film becomes an optical film exhibiting negative birefringence having the relationship among the three-dimensional refractive indexes of (nz>ny≧nx) or (nz>nx≧ny) as shown in FIG. 3. In this regard, the relationship between ny and nx can be controlled by a stretching ratio in the x-axis and y-axis as molding/processing conditions in the biaxial stretching.

If desired, the optical film exhibiting negative birefringence according to the present invention may contain additives such as heat stabilizers or anti-ultraviolet stabilizers, or plasticizers so far as the addition does not deviate from the object of the invention. Any additives or stabilizers usually known for resin materials can be used. In the optical film exhibiting negative birefringence according to the present invention, to protect the surface of the optical film, a hardcoat or the like may be provided. Conventional hard coating agents can be used.

The optical film exhibiting negative birefringence according to the present invention preferably has a refractive index of 1.50 or more. The films having a Tg of 100° C. or higher, preferably 120° C. or higher, and more preferably 140° C. or higher are preferable from the standpoints of manufacture of optical devices such as LCD and practical heat resistance as optical devices.

In addition to the single use, the optical film exhibiting negative birefringence according to the present invention can be laminated with the same kind or different kind of an optical material and provided for use, thereby further controlling the optical characteristics. Examples of the optical material to be laminated include polarized plates made of a combination of polyvinyl alcohol/dye/acetyl cellulose and polycarbonate-made stretched and oriented films. However, it should not be construed that the invention is limited thereto.

The optical film exhibiting negative birefringence according to the present invention is suitably used as an optical compensating member for liquid crystal display element. Examples thereof include retardation films for LCD such as STN type LCD, TFT-TN type LCD, OCB type LCD, VA type LCD, and IPS type LCD; ½ wavelength plates; ¼ wavelength plates; inverse wavelength dispersion characteristic films; optical compensating films; color filters; laminated films with a polarized plate; and polarized plate optical compensating films. The present invention is not limited to these applications, but the invention can be broadly applied to the case where negative birefringence is applied.

The resin composition for optical film according to the present invention is a resin composition having excellent heat resistance and dynamic characteristic and having excellent characteristics as a composition for optical films exhibiting negative birefringence, and an optical film comprising the same is excellent in heat resistance and dynamic characteristic and can be suitably used for optical films required to have negative birefringence.

The present invention is described in more detail by reference to the following Examples, but it should be understood that the invention is not construed as being limited thereto.

Measurement methods of respective physical property values are described below.

Measurement of Light Transmittance

As one of evaluation items of the transparency, light transmittance was measured according to JIS K7150 (1981).

Measurement of Haze

As one of evaluation items of the transparency, haze was measured according to JIS K7150 (1981).

Judgment of Positive and Negative of Birefringence

Positive and negative of birefringence was judged by the additive color judgment by a λ/4 plate using a polarization microscope described in Kobunshisozai No Henkokenbikyo Nyumon (written by Hiroshi Awaya and published by Agune Gijutsu Center, Chaprter 5, pp. 78-82 (2001)).

Measurement of Retardation Amount

Retardation amount was measured by a polarization microscope using a Senarmont compensator (Senarmont interference method) described in Kobunshisozai No Henkokenbikyo Nyumon (written by Hiroshi Awaya and published by Agune Gijutsu Center, Chaprter 5, pp. 94-96 (2001)).

Measurement of Refractive Index

Refractive index was measured according to JIS K7142 (1981).

Measurement of Glass Transition Temperature

Glass transition temperature was measured at a temperature rising rate of 10° C./min using a differential scanning colorimeter (a trade name: DSC2000, manufactured by Seiko Instruments Inc.).

Measurement of Weight Average Molecular Weight and Number Average Molecular Weight

Weight average molecular weight (Mw) and number average molecular weight (Mn) as reduced into standard polystyrene, and molecular weight distribution (Mw/Mn) as a ratio thereof were measured from an elution curve using a gel permeation chromatograph (GPC) (a trade name: HLC-802A, manufactured by Tosoh Corporation).

Measurement of Three-Dimensional Refractive Index

Three-dimensional refractive index was measured using a sample-inclined automatic birefringence analyzer (a trade name: KOBRA-21, manufactured by Oji Scientific Instruments).

Judgment of Dynamic Characteristic

The presence or absence of occurrence of cracks during shrinkage upon volatilization of a solvent used in the preparation of a film by solvent casting was visually confirmed. A sample in which occurrence of cracks was confirmed is one causing breakage due to film shrinkage and was evaluated to be deteriorated in dynamic characteristic.

### EXAMPLE 1

In a one-liter autoclave, 400 ml of toluene as a polymerization solvent, 0.001 moles of perbutyl neodecanoate as a polymerization initiator, 0.42 moles of N-phenylmaleimide, and 4.05 moles of isobutene were charged, and the mixture was polymerized under a polymerization condition at a polymerization temperature of 60° C. for a polymerization time of 5 hours, to obtain an N-phenylmaleimide-isobutene copolymer (weight average molecular weight (Mw): 162,000, weight average molecular weight (Mw)/number average molecular weight (Mn): 2.6).

A blend of 50% by weight of the N-phenylmaleimide-isobutene copolymer and 50% by weight of an acrylonitrile-styrene copolymer (a trade name: Cevian N080, manufactured by Daicel Polymer Ltd., weight average molecular weight (Mw): 130,000, acrylonitrile residual group unit/styrene residual group unit (weight ratio): 29/71) was prepared, and a methylene chloride solution was prepared such that the concentration of the blend became 25% by weight. The methylene chloride solution was cast on a polyethylene terephthalate film (hereinafter abbreviated as “PET film”), the solvent was volatilized, and the residue was solidified and separated to obtain a film. The resulting separated film was further dried at 100° C. for 4 hours and then dried by increasing the temperature at an interval of 10° C. from 110° C. to 130 ° C. each for one hour. The resulting film was further dried at 120° C. for 4 hours using a vacuum dryer to obtain a film having a thickness of about 100 μm.

The thus obtained film had a light transmittance of 92%, a haze of 0.3%, a refractive index of 1.57, and a glass transition temperature (Tg) of 150° C., and was free from occurrence of cracks.

A small piece of 5 cm×5 cm was cut out from the film and stretched to +50% by subjecting to uniaxial free width stretching under a condition at a temperature of 160° C. and at a stretching rate of 5 mm/min using a biaxial stretch device (manufactured by Shibayama Scientific Co., Ltd.), to obtain an optical film. The resulting optical film exhibited negative birefringence and had three-dimensional refractive indexes of nx=1.5671, ny=1.5678, and nz=1.5677 and a retardation amount within the film plane per 100 μm of the optical film thickness, [Re=(nx−ny)d], of −70 nm, wherein d represents the optical film thickness. The resulting optical film was suitable as a retardation film exhibiting negative birefringence.

### EXAMPLE 2

In a one-liter autoclave, 400 ml of toluene as a polymerization solvent, 0.001 moles of perbutyl neodecanoate as a polymerization initiator, 0.42 moles of N-(2-methylphenyl)maleimide, and 4.05 moles of isobutene were charged, and the mixture was polymerized under a polymerization condition at a polymerization temperature of 60° C. for a polymerization time of 5 hours, to obtain an N-(2-methylphenyl)maleimide-isobutene copolymer (weight average molecular weight (Mw): 160,000, weight average molecular weight (Mw)/number average molecular weight (Mn): 2.7).

A blend of 50% by weight of the N-(2-methylphenyl)maleimide-isobutene copolymer and 50% by weight of an acrylonitrile-styrene copolymer (a trade name: Cevian N080, manufactured by Daicel Polymer Ltd., weight average molecular weight (Mw): 130,000, acrylonitrile residual group unit/styrene residual group unit (weight ratio): 29/71) was prepared, and a methylene chloride solution was prepared such that the concentration of the blend became 25% by weight. The methylene chloride solution was cast on a PET film, the solvent was volatilized, and the residue was solidified and separated to obtain a film. The resulting separated film was further dried at 100° C. for 4 hours and then dried by increasing the temperature at an interval of 10° C. from 110° C. to 120° C. each for one hour. The resulting film was further dried at 120° C. for 4 hours using a vacuum dryer to obtain a film having a thickness of about 100 μm.

The thus obtained film had a light transmittance of 88%, a haze of 0.5%, a refractive index of 1.56, and a glass transition temperature (Tg) of 150° C. and was free from occurrence of cracks.

A small piece of 5 cm×5 cm was cut out from the film and stretched to +50% by subjecting to uniaxial free width stretching under a condition at a temperature of 170° C. and at a stretching rate of 5 mm/min using a biaxial stretch device (manufactured by Shibayama Scientific Co., Ltd.), to obtain an optical film. The resulting optical film exhibited negative birefringence and had three-dimensional refractive indexes of nx=1.5593, ny=1.5600, and nz=1.5599 and a retardation amount within the film plane per 100 μm of the optical film thickness, [Re=(nx−ny)d], of −70 nm, wherein d represents the optical film thickness. The resulting optical film was suitable as a retardation film exhibiting negative birefringence.

### EXAMPLE 3

A blend consisting of 90% by weight of the N-(2-methylphenyl)-maleimide-isobutene copolymer obtained in Example 2 and 10% by weight of an acrylonitrile-butadiene-styrene copolymer (a trade name: Cevian VT-1 80, manufactured by Daicel Polymer Ltd., weight average molecular weight (Mw): 104,400, weight average molecular weight (Mw)/number average molecular weight (Mn): 2.9) was prepared, and a methylene chloride solution was prepared such that the concentration of the blend became 25% by weight. The methylene chloride solution was cast on a PET film, the solvent was volatilized, and the residue was solidified and separated to obtain a film. The resulting separated film was further dried at 100° C. for 4 hours and then dried by increasing the temperature at an interval of 10° C. from 120° C. to 160° C. each for one hour. Thereafter, the resulting film was dried at 180° C. for 4 hours using a vacuum dryer to obtain a film having a thickness of about 100 μm.

The thus obtained film had a light transmittance of 88%, a haze of 0.9%, a refractive index of 1.56, and a glass transition temperature (Tg) of 190° C. and was free from occurrence of cracks.

A small piece of 5 cm×5 cm was cut out from the film and stretched to +50% by subjecting to uniaxial free width stretching under a condition at a temperature of 210° C. and at a stretching rate of 5 mm/min using a biaxial stretch device (manufactured by Shibayama Scientific Co., Ltd.), to obtain an optical film. The resulting optical film exhibited negative birefringence and had three-dimensional refractive indexes of nx =1.5573, ny=1.5580, and nz=1.5579 and a retardation amount within the film plane per 100 μm of the optical film thickness, [Re=(nx−ny)d] of −60 nm, wherein d represents the optical film thickness. The resulting optical film was suitable as a retardation film exhibiting negative birefringence.

### EXAMPLE 4

A blend of 40% by weight of the N-phenylmaleimide-isobutene copolymer obtained in Example 1 and 60% by weight of an acrylonitrile-styrene copolymer (a trade name: Cevian N080, manufactured by Daicel Polymer Ltd., weight average molecular weight (Mw): 130,000, acrylonitrile residual group unit/styrene residual group unit (weight ratio): 29/71) was prepared, and a methylene chloride solution was prepared such that the concentration of the blend became 25% by weight. The methylene chloride solution was cast on a PET film, the solvent was volatilized, and the residue was solidified and separated to obtain a film. The resulting separated film was further dried at 60° C. for 4 hours and then dried by increasing the temperature at an interval of 10° C. from 80° C. to 90° C. each for one hour. Thereafter, the resulting film was dried at 90° C. for 4 hours using a vacuum dryer to obtain a film having a thickness of about 100 μm.

The thus obtained film had a light transmittance of 88%, a haze of 0.5%, a refractive index of 1.57, and a glass transition temperature (Tg) of 140° C. and was free from occurrence of cracks.

A small piece of 5 cm×5 cm was cut out from the film and stretched to +50% by subjecting to uniaxial free width stretching under a condition at a temperature of 130° C. and at a stretching rate of 5 mm/min using a biaxial stretch device (manufactured by Shibayama Scientific Co., Ltd.), to obtain an optical film. The resulting optical film exhibited negative birefringence and had three-dimensional refractive indexes of nx=1.5675, ny=1.5678, and nz=1.5678 and a retardation amount within the film plane per 100 μm of the optical film thickness, [Re=(nx−ny)d], of −35 nm, wherein d represents the optical film thickness. The resulting optical film was suitable as a retardation film exhibiting negative birefringence.

### EXAMPLE 5

An optical film was obtained in the same manner as in Example 1, except that the cut small piece was stretched to +50% in the two directions within the film plane by subjecting to biaxial simultaneous stretching in place of stretching to +50% by uniaxial free width stretching. The resulting optical film exhibited negative birefringence and had three-dimensional refractive indexes of nx=1.5667, ny=1.5667, and nz=1.5670, a retardation amount within the film plane per 100 μm of the optical film thickness, [Rexy=(nx−ny)d], of 0 nm, and a retardation amount outside the film plane, [Rexz=(nx−nz)d], of −35 nm, wherein d represents the optical film thickness. The resulting optical film was suitable as a retardation film exhibiting negative birefringence.

### COMPARATIVE EXAMPLE 1

A methylene chloride solution was prepared such that the concentration of the N-phenylmaleimide-isobutene copolymer obtained in Example 1 became 25% by weight. The methylene chloride solution was cast on a PET film, the solvent was volatilized, and the residue was solidified and separated to obtain a film. The resulting separated film was further dried at 100° C. for 4 hours and then dried by increasing the temperature at an interval of 10° C. from 120° C. to 160° C. each for one hour. The resulting film was further dried at 180° C. for 4 hours using a vacuum dryer to obtain a film having a thickness of about 100 μm.

The thus obtained film had a light transmittance of 92%, a haze of 0.3%, a refractive index of 1.57, and a glass transition temperature (Tg) of 192° C. In this film, occurrence of fine cracks was confirmed.

A small piece of 5 cm×5 cm was cut out from the film and stretched to +50% by subjecting to uniaxial free width stretching under a condition at a temperature of 210° C. and at a stretching rate of 15 mm/min using a biaxial stretch device (manufactured by Shibayama Scientific Co., Ltd.), to obtain a stretched film. The resulting stretched film exhibited positive birefringence and had three-dimensional refractive indexes of nx=1.5706, ny=1.5699, and nz=1.5699 and a retardation amount within the film plane per 100 μm of the stretched film thickness, [Re=(nx−ny)d], of +70 nm, wherein d represents the stretched film thickness. The resulting stretched film was brittle.

### COMPARATIVE EXAMPLE 2

A methylene chloride solution was prepared such that the concentration of the N-(2-methylphenyl)maleimide-isobutene copolymer obtained in Example 2 became 25% by weight. The methylene chloride solution was cast on a PET film, the solvent was volatilized, and the residue was solidified and separated to obtain a film. The resulting separated film was further dried at 60° C. for 4 hours and then dried by increasing the temperature at an interval of 10° C. from 80° C. to 90° C. each for one hour. Thereafter, the resulting film was further dried at 90° C. for 4 hours using a vacuum dryer to obtain a film having a thickness of about 100 μm.

The thus obtained film had a light transmittance of 88%, a haze of 0.5%, a refractive index of 1.56, and a glass transition temperature (Tg) of 202° C. In this film, occurrence of fine cracks was confirmed.

A small piece of 5 cm×5 cm was cut out from the film and stretched to +50% by subjecting to uniaxial free width stretching under a condition at a temperature of 220° C. and at a stretching rate of 5 mm/min using a biaxial stretch device (manufactured by Shibayama Scientific Co., Ltd.), to obtain a stretched film. The resulting stretched film exhibited negative birefringence and had three-dimensional refractive indexes of nx=1.5538, ny=1.5550, and nz=1.5550 and a retardation amount within the film plane per 100 μm of the stretched film thickness, [Re=(nx−ny)d], of −120 nm, wherein d represents the stretched film thickness. The resulting stretched film was brittle.

### COMPARATIVE EXAMPLE 3

A methylene chloride solution was prepared such that the concentration of an acrylonitrile-styrene copolymer (a trade name: Cevian N080, manufactured by Daicel Polymer Ltd., weight average molecular weight (Mw): 130,000, acrylonitrile residual group unit/styrene residual group unit (weight ratio): 29/71) became 60% by weight. The methylene chloride solution was cast on a PET film, the solvent was volatilized, and the residue was solidified and separated to obtain a film. The resulting separated film was further dried at 60° C. for 4 hours and then dried by increasing the temperature at an interval of 10° C. from 80° C. to 90° C. each for one hour. The resulting film was dried at 90° C. for 4 hours using a vacuum dryer to obtain a film having a thickness of about 100 μm.

The thus obtained film had a light transmittance of 92%, a haze of 0.3%, a refractive index of 1.57, and a glass transition temperature (Tg) of 102° C.

A small piece of 5 cm×5 cm was cut out from the film and stretched to +50% by subjecting to uniaxial free width stretching under a condition at a temperature of 120° C. and at a stretching rate of 5 mm/min using a biaxial stretch device (manufactured by Shibayama Scientific Co., Ltd.), to obtain a stretched film. The resulting stretched film exhibited negative birefringence and had three-dimensional refractive indexes of nx=1.5638, ny=1.5650, and nz=1.5650 and a retardation amount within the film plane per 100 μm of the stretched film thickness, [Re=(nx−ny)d], of −120 nm, wherein d represents the stretched film thickness. The resulting stretched film was inferior in heat resistance.

What is claimed is:

1. A resin composition for optical film exhibiting negative birefringence, which comprises:
(a) 30-95% by weight of a copolymer comprising an α-olefin residual group unit represented by the following formula (i): 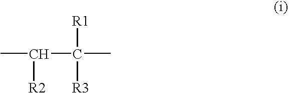
wherein R1, R2 and R3 each independently represent hydrogen or an alkyl group having 1-6 carbon atoms, and
an N-phenyl-substituted maleimide residual group unit represented by the following formula (ii): 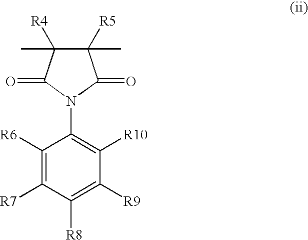
wherein R4 and R5 each independently represent hydrogen, or a linear or branched alkyl group having 1-8 carbon atoms; and R6, R7, R8, R9 and R10 each independently represent hydrogen, a halogen atom, a carboxylic acid, a carboxylic acid ester, a hydroxyl group, a cyano group, a nitro group, or a linear or branched alkyl group having 1-8 carbon atoms, and
having a weight average molecular weight, as reduced into standard polystyrene, of 5×10³ to 5×10⁶; and
(b) 70-5% by weight of at least one acrylonitrile-styrene based copolymer selected from an acrylonitrile-styrene copolymer and an acrylonitrile-butadiene-styrene copolymer, a weight ratio of an acrylonitrile residual group unit to a styrene residual group unit being 20/80 to 35/65, and having a weight average molecular weight, as reduced into standard polystyrene, of 5×10³ to 5×10⁶.

2. The resin composition for optical film as claimed in claim 1, wherein the copolymer (a) is at least one selected from the group consisting of an N-phenylmaleimide-isobutene copolymer and an N-(2-methylphenyl)maleimide-isobutene copolymer.

3. An optical film exhibiting negative birefringence, which comprises:
(a) 30-95% by weight of a copolymer comprising an α-olefin residual group unit represented by the following formula (i): 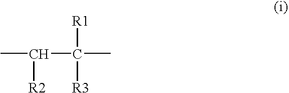
wherein R1, R2 and R3 each independently represent hydrogen or an alkyl group having 1-6 carbon atoms, and
an N-phenyl-substituted maleimide residual group unit represented by the following formula (ii): 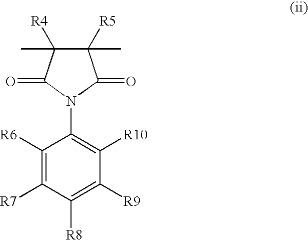
wherein R4 and R5 each independently represent hydrogen, or a linear or branched alkyl group having 1-8 carbon atoms; and R6, R7, R8, R9 and R10 each independently represent hydrogen, a halogen atom, a carboxylic acid, a carboxylic acid ester, a hydroxyl group, a cyano group, a nitro group, or a linear or branched alkyl group having 1-8 carbon atoms, and
having a weight average molecular weight, as reduced into standard polystyrene, of 5×10³ to 5×10⁶; and
(b) 70-5% by weight of at least one acrylonitrile-styrene based copolymer selected from an acrylonitrile-styrene copolymer and an acrylonitrile-butadiene-styrene copolymer, a weight ratio of an acrylonitrile residual group unit to a styrene residual group unit being 20/80 to 35/65, and having a weight average molecular weight, as reduced into standard polystyrene, of 5×10³ to 5×10⁶.

4. The optical film as claimed in claim 3, wherein the copolymer (a) is at least one selected from the group consisting of an N-phenylmaleimide-isobutene copolymer and an N-(²-methylphenyl)maleimide-isobutene copolymer.

5. The optical film as claimed in claim 3 or 4, wherein when a stretching direction within a film plane is defined as an x-axis, a direction within a film plane and perpendicular to the x-axis is defined as a y-axis, a direction outside the film plane and perpendicular to the stretching direction is defined as a z-axis, a refractive index in the x-axis direction is defined as nx, a refractive index in the y-axis direction is defined as ny, and a refractive index in the z-axis direction is defined as nz, the relationship among three-dimensional refractive indexes is (nz≧ny>nx) or (ny≧nz>nx).

6. The optical film as claimed in claim 3 or 4, wherein when a stretching direction is defined as an x-axis and a y-axis within a film plane, a direction outside the film plane and perpendicular to the x-axis and y-axis is defined as a z-axis, a refractive index in the x-axis direction is defined as nx, a refractive index in the y-axis direction is defined as ny, and a refractive index in the z-axis direction is defined as nz, the relationship among three-dimensional refractive indexes is (nz>ny≧nx) or (nz>nx≧ny).

7. A process of producing an optical film exhibiting negative birefringence, which comprises:
forming a resin composition for optical film exhibiting negative birefringence, which comprises:
(a) 30-95% by weight of a copolymer comprising an α-olefin residual group unit represented by the following formula (i): 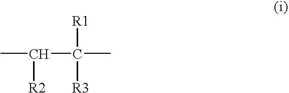
wherein R1, R2 and R3 each independently represent hydrogen or an alkyl group having from 1 to 6 carbon atoms, and
an N-phenyl-substituted maleimide residual group unit represented by the following formula (ii): 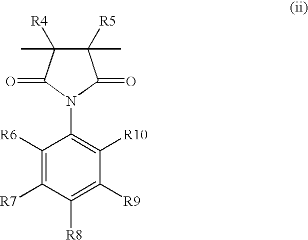
wherein R4 and R5 each independently represent hydrogen or a linear or branched alkyl group having 1-8 carbon atoms; and R6, R7, R8, R9 and R10 each independently represent hydrogen, a halogen atom, a carboxylic acid, a carboxylic acid ester, a hydroxyl group, a cyano group, a nitro group, or a linear or branched alkyl group having 1-8 carbon atoms, and
having a weight average molecular weight, as reduced into standard polystyrene, of 5×10³ to 5×10⁶; and
(b) 70-5% by weight of at least one acrylonitrile-styrene based copolymer selected from an acrylonitrile-styrene copolymer and an acrylonitrile-butadiene-styrene copolymer, a weight ratio of an acrylonitrile residual group unit to a styrene residual group unit being 20/80 to 35/65, and having a weight average molecular weight, as reduced into standard polystyrene, of 5×10³ to 5×10⁶ into a film; and
stretching and orienting the film at a temperature in the range of from [(glass transition temperature of the resin composition)−20° C.] to [(glass transition temperature of the resin composition)+20° C.].

8. The process as claimed in claim 7, wherein the stretching and orientation are uniaxial stretching and orientation.

9. The process as claimed in claim 7, wherein the stretching and orientation are biaxial stretching and orientation.

10. A retardation film comprising an optical film as claimed in claim 3.
